(19) United States
(12) Patent Application Publication
(10) Pub. No.: US 2005/0143030 A1
(43) Pub. Date: Jun. 30, 2005

(54) Receiving apparatus

(75) Inventors: Yuki Kuriki, Kawagoe-shi (JP); Kazuhiko Takahashi, Kawagoe-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/003,762

(22) Filed: Dec. 6, 2004

(30) Foreign Application Priority Data
Dec. 26, 2003 (JP) P2003-435496

(51) Int. Cl. H04B 1/00

(52) U.S. Cl. 455/131; 455/130

(57) ABSTRACT

A receiving apparatus receives a radio wave including an analog sound modulated wave signal, a digital sound modulated wave signal, and a digital character/image modulated wave signal by a receiving device. The analog sound modulated wave signal is demodulated by an analog demodulating device. The digital sound modulated wave signal is demodulated by a digital demodulating device. A determining device determines whether the reception level of the radio wave is equal to or higher than a predetermined level on the basis of a radio frequency signal obtained by reception of the radio wave. A selecting device selects one of the demodulating devices which generate a sound demodulated signal from a result of determination made by the determining device. A sound output device outputs sound by a sound demodulated signal from the selected demodulating device.

### BACKGROUND OF THE INVENTION

1. Field of the Invention

The present invention relates to a receiving apparatus for receiving radio waves including an analog sound modulated wave signal and a digital sound modulated wave signal. The use of the invention is not limited to the receiving apparatus.

2. Description of the Related Art

In recent years, digitization of radio broadcasting using ground waves is being promoted as digital radio broadcasting using a satellite develops, and a radio receiver adapted to the digital broadcasting using ground waves is being spread. A digital signal is added to the existing analog radio waves transmitted from a broadcast station, and the radio receiver can receive the same broadcast program by both the analog radio waves and the digital signal.

FIG. 1 shows an RF device of the radio receiver. As shown in FIG. 1, the RF device 100 of the radio receiver has, like normal radio receiver of only the analog system, an antenna 101, an attenuator 102 for attenuating an RF signal input from the antenna 101, a band pass filter 103 for regulating a band of the RF signal attenuated by the attenuator 102, an amplifier 104 for amplifying the RF signal output from the band pass filter 103, a band pass filter 105 for regulating a band of the RF signal amplified by the amplifier 104, a voltage controlled oscillator 106, a mixer 107 for mixing the RF signal output from the band pass filter 105 and an oscillation signal of the voltage controlled oscillator 106, there by generating an IF signal, and an AGC circuit 108 for controlling an attenuation amount of the attenuator 102 on the basis of the output from the band pass filter 105 or mixer 107 and controlling the gain of the amplifier 104.

The attenuator 102 used in the RF device 100 attenuates the level difference between the antenna input level at which IM (Inter-Modulation) interference occurs and the maximum antenna input level from the broadcast station. As the attenuator 102, an attenuator which obtains an attenuation amount by an impedance division ratio using a direct current resistance value when a forward current is passed by using a pin-diode or the like or an attenuator using a dual-gate type FET having a gate dedicated to adjust the gain for an RF amplifier is often used.

As such a radio receiver, an OFDM receiver is disclosed in which a distortion caused by improper control that occurs when the power ratio of each of carriers of an OFDM becomes excessive, for example, in a DAB mobile receiver is suppressed. The OFDM receiver calculates the center frequency of an OFDM modulated wave, that is, the power in the center point of an FFT in a demodulator. A signal of the calculated value is transmitted as a control signal to an AGC amplifier for the IF stage and the like via a time constant circuit. The AGC amplifier for the IF stage or the like amplifies an output from a mixer in the second stage with respect to a control signal of a predetermined value or a larger value from the time constant circuit and outputs the amplified signal to an AGC block of the IF stage. As a result, an output of an attenuator is suppressed (refer to, for example, Japanese Patent Application Laid-open No. 11-46151).

### SUMMARY OF THE INVENTION

However, in the conventional technique, demodulation of an analog signal and a digital signal is switched according to BER (Bit Error Rate) obtained at the time of demodulating a digital signal. Therefore, in the case where the field intensity of an RF signal input by receiving an analog modulated wave is high to such a degree that IM interference occurs, that is, in the case where an RF signal is excessively input, if the BER is high, demodulation of a digital modulated wave is switched to demodulation of an analog modulated wave. It causes one problem such that the reception quality deteriorates and the sound quality deteriorates.

On the other hand, in the case where the attenuator for suppressing excessive input of the RF signal is provided as in the conventional technique, the number of parts increases and it causes one problem such that the size and weight of the radio receiver cannot be reduced. Further, one problem also occurs such that the price of the radio receiver increases.

The invention according to the present invention relates to a receiving apparatus comprising:
a receiving device which receives a radio wave including at least an analog sound modulated wave signal and a digital sound modulated wave signal;
an analog demodulating device which demodulates the analog sound modulated wave signal received by said receiving device;
a digital demodulating device which demodulates the digital sound modulated wave signal received by said receiving device;
a determining device which determines whether a reception level of said radio wave is equal to or higher than a predetermined level or not on the basis of a radio frequency signal obtained by receiving said radio wave by said receiving device;
a selecting device which selects either said analog demodulating device or said digital demodulating device on the basis of a result of determination made by said determining device; and
a sound output device which outputs sound on the basis of the sound demodulated signal obtained from the demodulating device selected by said selecting device.

### BRIEF DESCRIPTION OF THE DRAWINGS

FIG. 1 is a block diagram showing the hardware configuration of an RF device of a conventional radio receiver.

FIG. 2 is a frequency characteristic diagram of a radio wave received by a receiving apparatus according to an embodiment of the invention.

FIG. 3 is a front view schematically showing the receiving apparatus according to the embodiment of the invention.

FIG. 4 is a block diagram showing a functional configuration of the receiving apparatus according to the embodiment of the invention.

FIG. 5 is a block diagram showing a hardware configuration of a first example of the receiving apparatus according to the embodiment.

FIG. 6 is a flowchart showing the procedure in the first example of the receiving apparatus according to the embodiment.

FIG. 7 is a block diagram showing a hardware configuration of a second example of the receiving apparatus according to the embodiment.

FIG. 8 is a flowchart showing a procedure in the second example of the receiving apparatus according to the embodiment.

### DESCRIPTION OF PREFERRED EMBODIMENTS OF THE INVENTION

A preferred embodiment of a receiving apparatus according to the invention will be described in detail hereinbelow with reference to the appended drawings. First, frequency characteristics of a radio wave received by the receiving apparatus according to the embodiment of the invention will be described. FIG. 2 is a frequency characteristic diagram of a radio wave received by the receiving apparatus according to the embodiment of the invention. The vertical axis of the characteristic diagram indicates signal level and the horizontal axis thereof indicates frequency. The radio wave includes an analog sound modulated wave signal fa and a digital sound modulated wave signal fd and is transmitted from an arbitrary broadcast station. The analog sound modulated wave signal fa is, for example, a sound signal such as an FM wave or AM wave. The digital modulated wave signal fd includes, for example, a digital sound modulated wave signal which is the same sound data as the analog sound modulated wave signal fa and also a digital character/image modulated wave signal such as character data or still image data such as the name of a broadcast station, frequency, program name, title of a music piece, time, weather, news, advertisement, or the like.

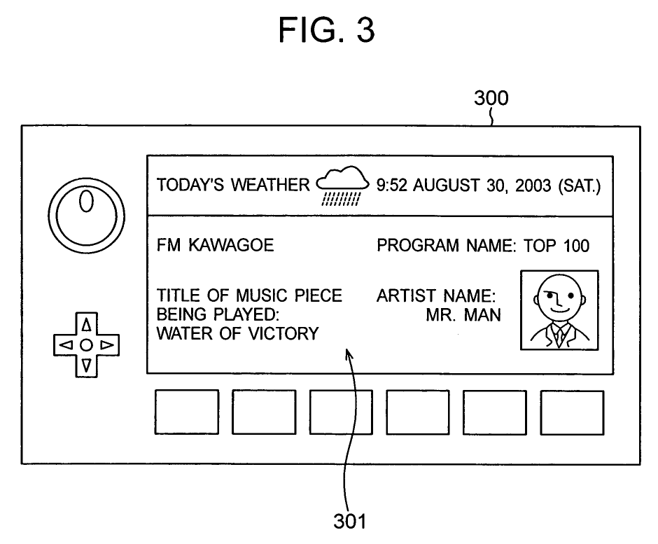

The receiving apparatus according to the embodiment of the invention will be schematically shown. FIG. 3 is a front view schematically showing the receiving apparatus according to the embodiment of the invention. As shown in FIG. 3, a receiving apparatus 300 has, for example, a display such as a liquid crystal display 301. By demodulating the digital character/image modulated wave signal, characters or a still image of the name of a broadcast station, frequency, program name, title of a music piece, time, weather, news, advertisement, or the like can be displayed on the liquid crystal display 301.

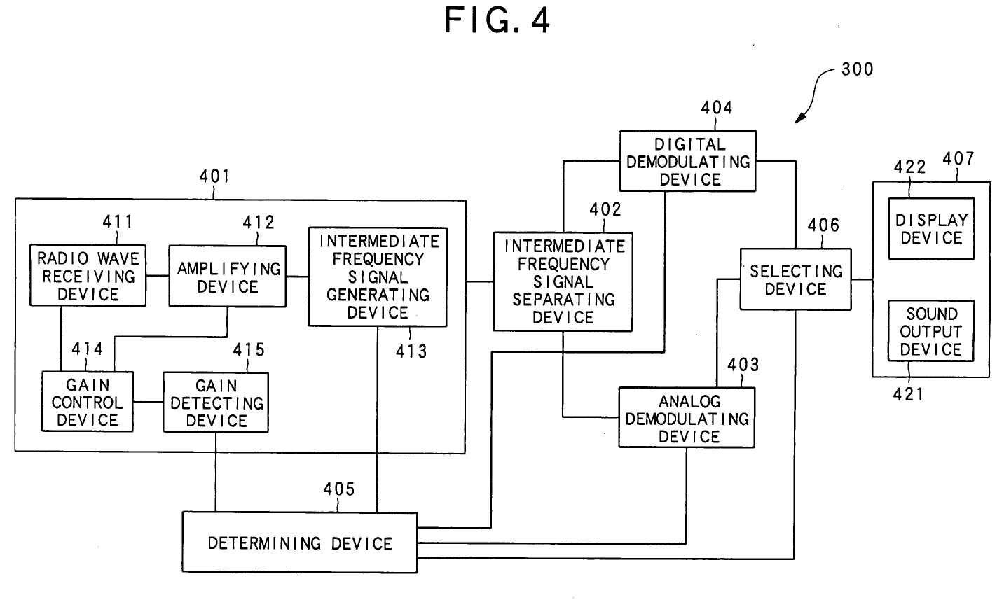

The functional configuration of the receiving apparatus according to the embodiment of the invention will now be described. FIG. 4 is a block diagram showing the functional configuration of the receiving apparatus 300 according to the embodiment of the invention. The receiving apparatus 300 is constructed by a receiving device 401, an intermediate frequency signal separating device 402, an analog demodulating device 403, a digital demodulating device 404, a determining device 405, a selecting device 406, and an output device 407.

The receiving device 401 receives a radio wave including an analog sound modulated wave signal, a digital sound modulated wave signal, and a digital character/image modulated wave signal and generates an intermediate frequency signal. Concretely, the receiving device 401 has a radio wave receiving device 411, an amplifying device 412, an intermediate frequency signal generating device 413, a gain control device 414, and a gain detecting device 415. The radio wave receiving device 411 receives the radio wave including the analog modulated wave signal, digital modulated wave signal, and digital character/image modulated wave signal. The amplifying device 412 amplifies a radio frequency signal obtained by receiving a radio wave by the radio wave receiving device 411.

The intermediate frequency signal generating device 413 generates an intermediate frequency signal from the radio frequency signal amplified by the amplifying device 412. The gain control device 414 controls the gain of the radio frequency signal amplified by the amplifying device 412 on the basis of an output received from the radio wave receiving device 411, amplifying device 412, or intermediate frequency signal generating device 413. The gain detecting device 415 detects whether or not the gain of the radio frequency signal is a predetermined gain or higher by the gain control device 414. When it is detected that the gain of the radio frequency signal is equal to or higher than the predetermined gain, the receiving device 401 excessively receives the radio frequency signal. On the other hand, when it is detected that the gain of the radio frequency signal is less than the predetermined gain, the receiving device 401 stably receives the radio frequency signal.

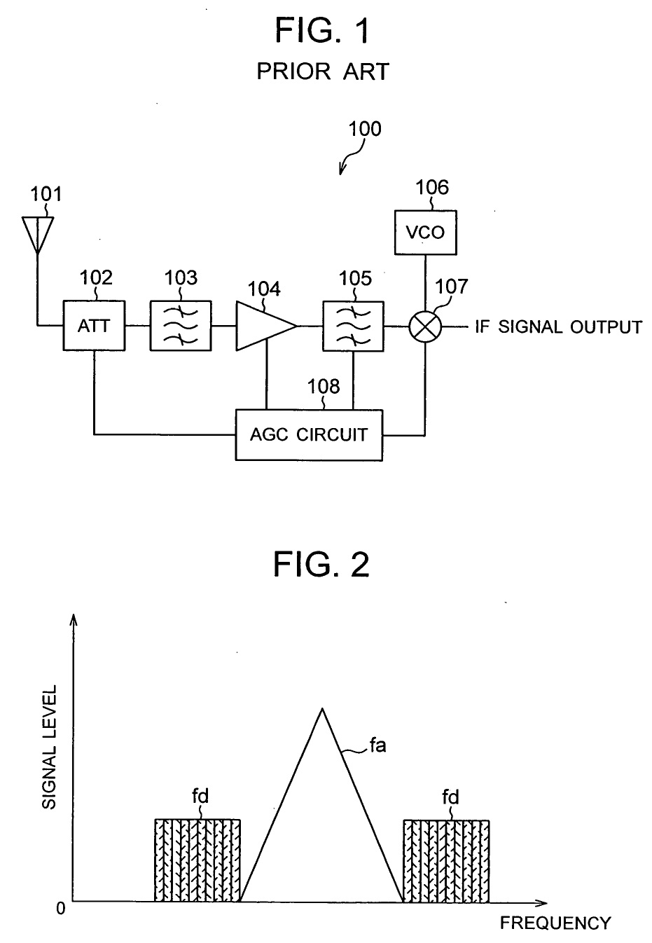

The intermediate frequency signal separating device 402 separates the analog modulated wave signal and the digital modulated wave signal (refer to FIG. 1) included in the intermediate frequency signal output from the intermediate frequency signal generating device 413, outputs the analog modulated wave signal to the analog demodulating device 403, and outputs the digital modulated wave signal to the digital demodulated device 404. The analog demodulating device 403 demodulates the analog sound modulated wave signal separated by the intermediate frequency signal separating device 402. The digital demodulating device 404 demodulates the digital sound modulated wave signal and the digital character/image modulated wave signal separated by the intermediate frequency signal separating device 402.

The determining device 405 determines whether the level of the received radio wave is equal to or higher than the predetermined level or not on the basis of the radio frequency signal obtained by receiving the radio wave by the receiving device 401. As an example of the determining process of the determining device 405, an intermediate frequency signal generated by the intermediate frequency signal generating device 413 in the receiving device 401 is used and whether the signal level of the intermediate frequency signal is equal to the predetermined signal level or not can be determined. When it is determined that the signal level of the intermediate frequency signal is equal to or higher than the predetermined signal level, it can be determined that a desired wave is received.

As an example of the determining process of the determining device 405, a gain level detected by the gain detecting device 415 is used and whether the gain level is equal to or higher than the predetermined level can be determined. When it is determined that the gain level is equal to or higher than the predetermined level, it can be determined that the reception level is too high, that is, the input radio frequency signal is excessive. Therefore, by using the signal level of the intermediate frequency signal and the gain level of the gain detecting device 415, whether the sensitivity of the received radio wave is good or not can be determined.

Further, as an example of the determining process of the determining device 405, the BER (Bit Error Rate) in demodulation by the digital demodulating device 404 is used and whether the BER is equal to or higher than the predetermined rate can be also determined. In such a manner, whether the quality of digital sound output by decoding of the digital demodulating device 404 is good or not can be determined.

The selecting device 406 selects either the analog demodulating device 403 or the digital demodulating device 404 on the basis of a result of determination made by the determining device 405. By the operation, a decoder for generating a sound decoded signal to be output can be determined. The output device 407 has a sound output device 421 and a display device 422. The sound output device 421 outputs sound on the basis of the sound demodulated signal obtained from the demodulating device (403 or 404) selected by the selecting device 406. The display device 422 displays characters or an image on the screen by the character/image demodulated signal obtained by demodulating the digital character/image modulated wave signal by the digital demodulating device 404.

As described above, in the receiving apparatus 300 according to the embodiment, the reception level of a received radio wave is determined by using the signal level of the intermediate frequency signal or the gain level detected by the gain detecting device 415, and whether the reception sensitivity is good or not can be determined. Therefore, in the case where the signal level of the intermediate frequency signal is equal to or higher than the predetermined signal level or in the case where the gain level is equal to or higher than the predetermined level, the selecting device 406 selects the digital demodulating device 404. Thus, sound can be output by using the digital sound demodulated signal obtained by demodulation of the digital demodulating device 404 and the user can listen to digital sound of high sensitivity.

On the other hand, in the case where the signal level of the intermediate frequency signal is less than the predetermined signal level and in the case where the gain level is less than the predetermined level, the selecting device 406 selects the analog demodulating device 403. Therefore, in the case where digital sound cannot be output with high sensitivity, sound is output by using the analog sound demodulated signal obtained by demodulation of the analog demodulating device 403. Consequently, when the analog sound is output, the radio frequency signal is not excessively received always. It is therefore unnecessary to attenuate the radio frequency signal by using an attenuator, so that the attenuator is unnecessary. Thus, the number of parts can be decreased and the size and weight of the receiving apparatus 300 can be reduced. Further, by using the BER, the output sound can be switched depending on the quality of the output sound and the user can listen to digital sound of high sensitivity and high quality.

### EXAMPLE 1

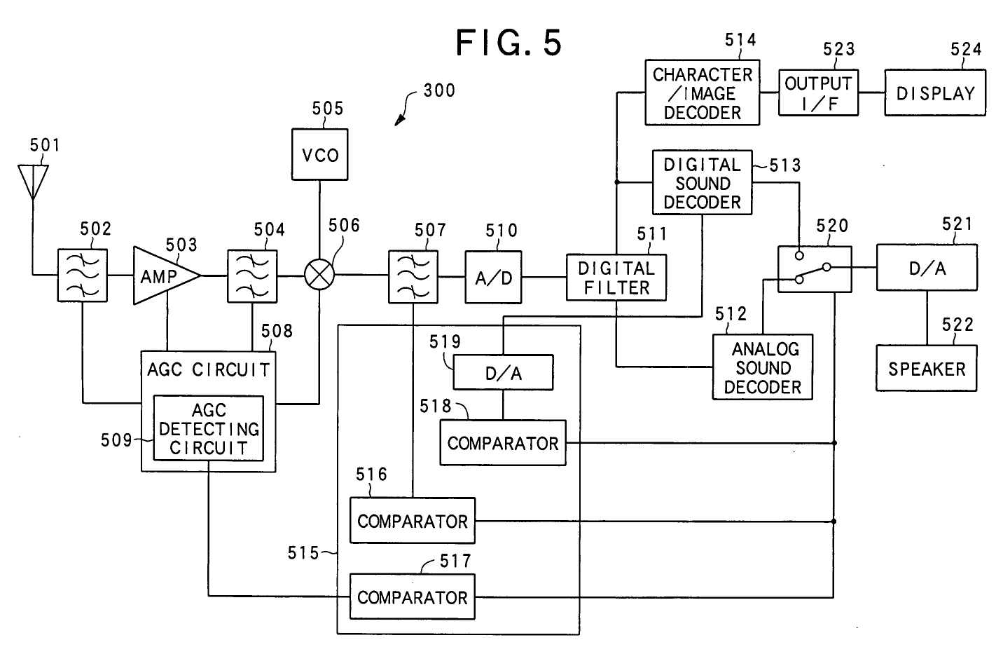

A first example of the receiving apparatus 300 according to the embodiment will be described. FIG. 5 is a block diagram showing the hardware configuration of the first example of the receiving apparatus 300 according to the embodiment. As shown in FIG. 5, the receiving apparatus 300 of the first example has: an antenna 501 for receiving a radio wave including an analog sound modulated wave signal, a digital sound modulated wave signal, and a digital character/image modulated wave signal; and a first band pass filter 502 for regulating the band of the radio frequency signal obtained from the antenna 501. The antenna 501 and the first band pass filter 502 construct the radio wave receiving device 411 shown in FIG. 4.

An amplifier 503 amplifies the radio frequency signal output from the first band pass filter 502. The amplifier 503 is a component of the amplifying device 412 shown in FIG. 4. A second band pass filter 504 regulates a band of the radio frequency signal amplified by the amplifier 503 and outputs the resultant to a mixer 506. A voltage controlled oscillator (VCO) 505 outputs an oscillation signal of a predetermined frequency to the mixer 506. The mixer 506 mixes the radio frequency signal output from the second band pass filter 504 with the oscillation signal output from the voltage controlled oscillator 505, thereby generating an intermediate frequency signal. A third band pass filter 507 regulates the intermediate frequency signal output from the mixer 506 to a frequency band of a desired wave. The second band pass filter 504, voltage controlled oscillator 505, mixer 506, and third band pass filter 507 construct the intermediate frequency signal generating device 413 shown in FIG. 4.

An AGC (Auto Gain Control) circuit 508 controls the gain of the amplifier 503 on the basis of the field intensity obtained from the mixer 506, first band pass filter 502, or second band pass filter 504. The AGC circuit 508 is a component of the gain control device 414 shown in FIG. 4. The AGC circuit 508 includes an AGC detecting circuit 509. In the AGC detecting circuit 509, a threshold voltage for detecting whether the field intensity obtained from the mixer 506, first band pass filter 502, or second band pass filter 504 is equal to or higher than a predetermined level or not is set. The field intensity equal to or higher than the threshold voltage is detected as an AGC voltage. In such a manner, excessive input of the radio frequency signal caused by interference of an interfering wave to a received wave can be detected. The AGC detecting circuit 509 is a component of the gain detecting device 415 shown in FIG. 4.

An A/D converter 510 converts an intermediate frequency signal output from the third band pass filter 507 to a digital signal. A digital filter 511 frequency decomposes the digitally converted intermediate frequency signal, outputs the analog modulated wave signal to an analog sound decoder 512, and outputs the digital modulated wave signal to a digital sound decoder 513 and a character/image decoder 514. Therefore, intermediate frequency signal is separated. The A/D converter 510 and the digital filter 511 construct the intermediate frequency signal separating device 402 shown in FIG. 4.

The analog sound decoder 512 receives the analog modulated wave signal separated by the digital filter 511 and demodulates the analog modulated wave signal into an analog sound demodulated signal. The analog sound decoder 512 is a component of the analog demodulating device 403 shown in FIG. 4.

The digital sound decoder 513 receives the digital sound modulated wave signal included in the digital modulated wave signal separated by the digital filter 511 and demodulates the digital sound modulated wave signal to a digital sound demodulated signal. The character/image decoder 514 receives the digital character/image modulated wave signal included in the digital modulated wave signal separated by the digital filter 511 and demodulates the input digital character/image modulated wave signal to a character/image demodulated signal. The digital sound decoder 513 and the character/image decoder 514 construct the digital demodulating device 404 shown in FIG. 4.

A determining circuit 515 is constructed by first to third comparators 516 to 518 and a D/A converter 519. In the first comparator 516, a predetermined threshold voltage is preset. The first comparator 516 compares the threshold voltage with the signal level of the intermediate frequency signal output from the third band pass filter 507. The threshold voltage is a value corresponding to reception sensitivity of the intermediate frequency signal, at which digital sound can be properly output.

When it is determined that the signal level of the intermediate frequency signal is less than the threshold voltage, the reception sensitivity of the intermediate frequency signal is less than the predetermined sensitivity, and the first comparator 516 outputs a low-level signal to a selecting circuit 520. On the other hand, when it is determined that the signal level of the intermediate frequency signal is equal to or higher than the threshold voltage, the intermediate frequency signal is equal to or higher than predetermined sensitivity, and the first comparator 516 outputs a high-level signal to the selecting circuit 520.

The second comparator 517 determines whether an AGC voltage is detected by the AGC detecting circuit 509 or not. Concretely, when the AGC voltage is supplied from the AGC detecting circuit 509, the second comparator 517 outputs a high-level signal to the selecting circuit 520. When the AGC voltage is not supplied from the AGC detecting circuit 509, the second comparator 517 outputs a low-level signal to the selecting circuit 520.

The D/A converter 519 converts the BER (Bit Error Rate) detected at the time of the decoding process of the digital sound decoder 513 into an analog signal and inputs the analog signal to the third comparator 518. In the third comparator 518, a threshold value for determining whether the BER detected by the digital sound decoder 513 is a permissible level value or not is set.

When it is determined that the BER detected by the digital sound decoder 513 is the threshold voltage or higher than the voltage, the BER is equal to or higher than the permissible level, that is, the sound quality of the digital sound is lower than the sound quality of the permissible level, and the third comparator 518 outputs a low-level signal to the selecting circuit 520. On the other hand, when the BER is determined to be less than the threshold voltage, the BER is less than the permissible level, that is, the sound quality of the digital sound is higher than the sound quality of the permissible level, and the third comparator 518 outputs a high-level signal to the selecting circuit 520. The determining circuit 515 is a component of the determining device 405 shown in FIG. 4.

The selecting circuit 520 selects either the digital sound decoder 513 for demodulating the digital sound modulated wave signal or the analog sound decoder 512 for demodulating the analog modulated wave signal on the basis of output signals (high-level signal and low-level signal) output from the first to third comparators 516 to 518 of the determining circuit 515. Concretely, when the high-level signal is input from any of the first to third comparators 516 to 518, the selecting circuit 520 connects the digital sound decoder 513 and a D/A converter 521. On the other hand, when low level signals are received from all of the first to third comparators 516 to 518, the selecting circuit 520 connects the analog sound decoder 512 and the D/A converter 521. The selecting circuit 520 is a component of the selecting device 406 shown in FIG. 4.

The D/A converter 521 is connected to the analog sound decoder 512 or digital sound decoder 513 via the selecting circuit 520 and D/A converts the input analog sound demodulated signal or digital sound demodulated signal. A speaker 522 outputs the analog sound demodulated signal or digital sound demodulated signal output from the D/A converter 521 as sound. The D/A converter 521 and speaker 522 construct the sound outputting device 421 shown in FIG. 4.

An output I/F (interface) 523 is connected to the character/image decoder 514. The output I/F 523 is constructed by, concretely, for example, a graphic controller for controlling a whole display 524, a buffer memory such as a VRAM (Video RAM) for temporarily storing image information which can be immediately displayed, and a control IC for controlling the display 524 on the basis of image data output from the graphic controller. The display 524 is connected to the output I/F 523 and displays character/image data. The display 524 is constructed by, concretely, for example, a liquid crystal display 301 shown in FIG. 3, an LED or the like. The output I/F 523 and the display 524 construct the display device 422 shown in FIG. 4.

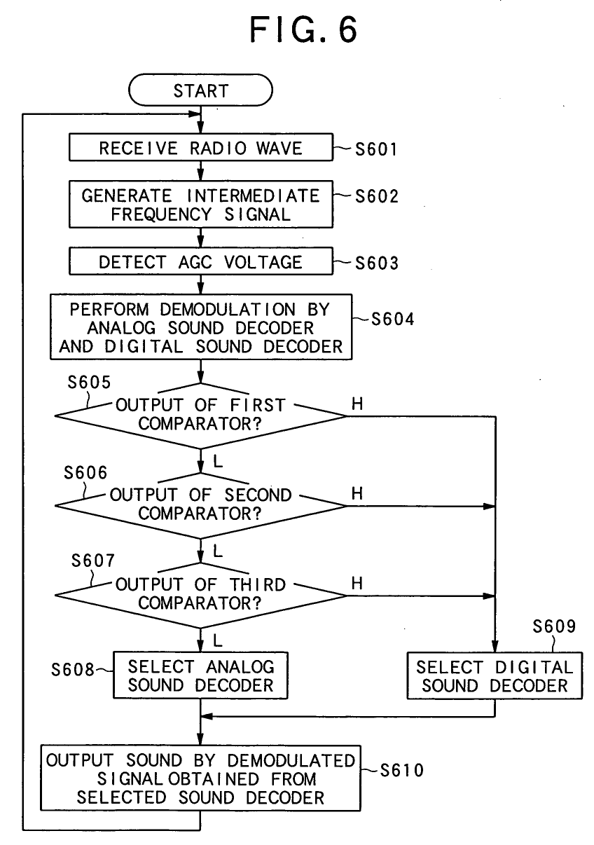

The procedure in the receiving apparatus 300 of the first example will now be described. FIG. 6 is a flowchart showing the procedure of the receiving apparatus 300 of the first example. First, the receiving apparatus 300 receives a radio wave including the analog modulated wave signal, digital modulated wave signal, and digital character/image modulated wave signal (step S601). An intermediate frequency signal is generated by the mixer 506 (step S602) and the AGC voltage is detected by the AGC detecting circuit 509 (step S603).

After that, demodulation is performed by the analog sound decoder 512 and digital sound decoder 513 (step S604). In the case where the output of the first comparator 516 is at the low level (L in step S605), the determining process by the second comparator 517 is performed (step S606). When the output of the second comparator 517 is at the low level (L in step S606), the determining process by the third comparator 518 is performed (step S607) When the output of the third comparator 518 is at the low level (L in step S607), the analog sound decoder 512 is selected by the selecting circuit 520 (step S608).

On the other hand, when the outputs of the first to third comparators 516 to 518 are at the high level (H in step S605, H in step S606, and H in step S607), the digital sound decoder 513 is selected by the selecting circuit 520 (step S609). Sound is output by the sound demodulated signal obtained from the selected sound decoder (step S610).

In the first example, reception sensitivity of the modulated wave can be determined by the first comparator 516. By the second comparator 517, whether or not the radio frequency signal is excessively input because the interference wave is included in the analog modulated wave can be determined. Further, the quality of digital sound data can be determined by the third comparator 518. Therefore, in the first example, the digital sound data can be output at high sensitivity and high quality with the simple configuration.

In the case where the radio frequency signal is excessively input, the digital sound decoder 513 is selected. In other words, when the analog sound decoder 512 is selected, the radio frequency signal is not excessively input. Consequently, without separately providing the receiving device 401 with an attenuator, analog sound can be properly output. Thus, as compared with the normal receiving apparatus 300 for receiving the radio wave including the analog modulated wave signal and the digital modulated wave signal, the number of parts can be decreased and the size and weight of the receiving apparatus 300 can be reduced. As the number of parts is reduced, the inexpensive receiving apparatus 300 can be provided.

### EXAMPLE 2

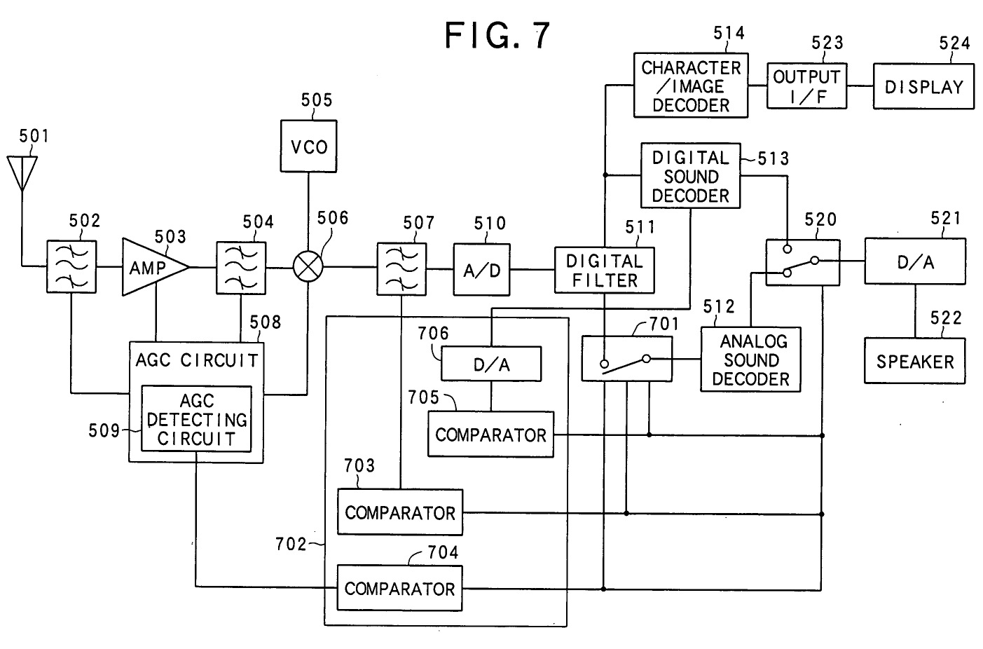

A second example of the receiving apparatus 300 according to the embodiment will now be described. FIG. 7 is a block diagram showing the hardware configuration of the second example of the receiving apparatus 300 of the embodiment. The receiving apparatus 300 of the second example executes or stops the demodulating process of the analog sound decoder 512. The same reference numerals are designated to components which are the same as those of the first example and their description will not be repeated.

At the preceding stage of the analog sound decoder 512 in the receiving apparatus 300 of the second example, an internal switch 701 is provided. The internal switch 701 is switched to ON or OFF in accordance with an output of a determining circuit 702 and executes or stops the demodulating process of the analog sound decoder 512. When the internal switch 701 is ON, the analog sound decoder 512 receives the analog sound modulated wave signal separated by the digital filter 511 and demodulates it to an analog sound demodulated signal. The internal switch 701 is connected to first to third comparators 703 to 705 provided in the determining circuit 702. The analog sound decoder 512 and the internal switch 701 construct the analog demodulating device 403 shown in FIG. 4.

The determining circuit 702 is constructed by the first to third comparators 703 to 705 and a D/A converter 706. In the first comparator 703, a predetermined threshold voltage is preset. The first comparator 703 compares the threshold voltage with the signal level of an intermediate frequency signal output from the third band pass filter 507. The threshold voltage is a value corresponding to reception sensitivity at which digital sound can be properly output.

In the case where the signal level of the intermediate frequency signal is determined to be less than the threshold voltage, the reception sensitivity of the intermediate frequency signal is less than the predetermined sensitivity, and the first comparator 703 outputs a low-level signal to the selecting circuit 520. On the other hand, when the signal level of the intermediate frequency signal is determined to be equal to or higher than the threshold voltage, the intermediate frequency signal is equal to or higher than predetermined sensitivity, and the first comparator 703 outputs a high-level signal to the selecting circuit 520.

The second comparator 704 determines whether the AGC voltage is detected by the AGC detecting circuit 509 or not. Concretely, when the AGC voltage is supplied from the AGC detecting circuit 509, the second comparator 704 outputs a high-level signal to the selecting circuit 520. When the AGC voltage is not supplied from the AGC detecting circuit 509, the second comparator 704 outputs a low-level signal to the selecting circuit 520.

The D/A converter 706 converts the BER (Bit Error Rate) detected at the time of the decoding process of the digital sound decoder 513 into an analog signal and inputs the analog signal to the third comparator 705. In the third comparator 705, the threshold value for determining whether the BER detected from the digital sound decoder 513 is a value of the permissible level or not is set.

In the case where the BER detected from the digital sound decoder 513 is determined to be equal to or higher than the threshold voltage, the BER is equal to or higher than the permissible level, that is, the quality of the digital sound is lower than that of the permissible level, and the third comparator 705 outputs a low-level signal to the selecting circuit 520. On the other hand, when it is determined that the BER is lower than the threshold voltage, the BER is lower than the permissible level, that is, the quality of the digital sound is higher than that of the permissible level. The third comparator 705 outputs a high-level signal to the selecting circuit 520. The determining circuit 702 is a component of the determining device 405 shown in FIG. 4.

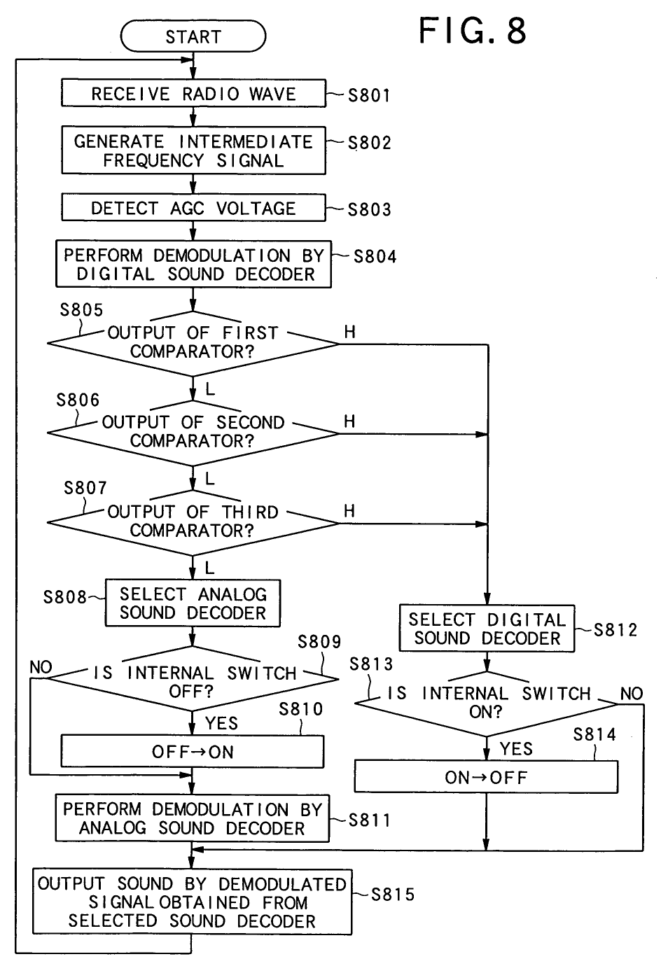

The procedure in the receiving apparatus 300 of the second example will now be described. FIG. 8 is a flowchart showing the procedure of the receiving apparatus 300 of the second example. First, the receiving apparatus 300 receives a radio wave including the analog modulated wave signal, digital modulated wave signal, and digital character/image modulated wave signal (step S801). An intermediate frequency signal is generated from the mixer 506 (step S802) and the AGC voltage is detected by the AGC detecting circuit 509 (step S803).

After that, demodulation is performed by the digital sound decoder 513 (step S804). In the case where the output of the first comparator 703 is at the low level (L in step S805), the determining process by the second comparator 704 is performed (step S806). When the output of the second comparator 704 is at the low level (L in step S806), the determining process by the third comparator 705 is performed (step S807). When the output of the third comparator 705 is at the low level (L in step S807), the analog sound decoder 512 is selected by the selecting circuit 520 (step S808).

After that, the ON/OFF state of the internal switch 701 is determined (step S809). In the case where the internal switch 701 is OFF (“Yes” in step S809), the internal switch 701 is switched to the ON state (step S810) When it is determined as “No” in step S810 or S809 and the internal switch 701 is turned ON, demodulation is performed by the analog sound decoder 512 (step S811).

On the other hand, when the outputs of the first to third comparators 703 to 705 are at the high level (H in step S805, H in step S806, and H in step S807) , the digital sound decoder 513 is selected by the selecting circuit 520 (step S812). After that, the ON/OFF State of the internal switch 701 is determined (step S813). In the case where the internal switch 701 is ON (“Yes” in step S813), the internal switch 701 is switched to the OFF state (step S814). When it is determined as “No” in step S814 or S813 and the internal switch 701 is turned OFF, sound is output by the demodulated signal obtained from the selected sound decoder (step S815).

In the second example, in a manner similar to the first example, digital sound data can be output with high sensitivity and high quality with the simple configuration. Without separately providing the receiving device 401 with an attenuator, analog sound can be properly output. Thus, in a manner similar to the first example, the number of parts can be decreased and the size and weight of the receiving apparatus 300 can be reduced. By reducing the number of parts, the inexpensive receiving apparatus 300 can be provided.

Further, the internal switch 701 is provided at the preceding stage of the analog sound decoder 512 and the ON/OFF state of the internal switch 701 is controlled in accordance with the result of determination of the determining circuit 702. Consequently, in the case of demodulating the digital sound modulated wave signal, the demodulating process of the analog sound decoder 512 can be stopped and the power can be saved. Thus, for example, in a portable receiving apparatus, drive time by a battery can be increased.

In the case where sound information included in the analog modulated wave signal and that included in the digital modulated wave signal are the same in the first and second examples, sound can be output by a demodulated signal of high sensitivity in accordance with the radio wave conditions. Even if the radio wave conditions change, the user can listen to sound of high quality with little influence of noise and the like. Further, in the case where the digital sound modulated wave signal and the character/image modulated wave signal are included in the digital modulated wave signal, irrespective of the results of determination of the determining circuits 515 and 702, the character/image modulated wave signal is always demodulated and the demodulated signal can be displayed on the display 524. Therefore, even in the case where the radio wave conditions change and the analog sound decoder 512 is consequently selected, while outputting analog sound by the analog sound demodulated signal, characters/image suitable for the analog sound can be displayed on the display 524.

As described above, in the receiving apparatus 300 according to the embodiment, sound can be output with high sensitivity and high definition by the simple configuration. Since an attenuator is unnecessary, because of decrease in the number of parts, the size and weight can be reduced. Thus, the inexpensive receiving apparatus 300 can be provided. For example, the receiving apparatus 300 according to the embodiment is useful for an HD (High Definition) radio receiver capable of demodulating both digital and analog signals and can be applied to, in particular, a portable radio receiver and an on-vehicle audio set.

The invention may be embodied in other specific forms without departing from the spirit thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

The entire disclosure of Japanese Patent Application No. 2003-435496 filed on Dec. 26, 2003 including the specification, claims, drawings and abstract is incorporated herein by reference in its entirety.

1. A receiving apparatus comprising:
a receiving device which receives a radio wave including at least an analog sound modulated wave signal and a digital sound modulated wave signal;
an analog demodulating device which demodulates the analog sound modulated wave signal received by said receiving device;
a digital demodulating device which demodulates the digital sound modulated wave signal received by said receiving device;
a determining device which determines whether a reception level of said radio wave is equal to or higher than a predetermined level or not on the basis of a radio frequency signal obtained by receiving said radio wave by said receiving device;
a selecting device which selects either said analog demodulating device or said digital demodulating device on the basis of a result of determination made by said determining device; and
a sound output device which outputs sound on the basis of the sound demodulated signal obtained from the demodulating device selected by said selecting device.

2. The receiving apparatus according to claim 1, wherein said receiving device has an intermediate frequency signal generating device which generates an intermediate frequency signal from said radio frequency signal, and
said determining device determines whether the reception level of said radio wave is equal to or higher than the predetermined level or not on the basis of the signal level of the intermediate frequency signal generated by said intermediate frequency signal generating device.

3. The receiving apparatus according to claim 1, wherein said receiving device comprises:
an amplifying device which amplifies said radio frequency signal;
a gain control device which controls the gain of the radio frequency signal amplified by said amplifying device; and
a gain detecting device which detects whether the gain of said radio frequency signal is equal to or higher than a predetermined gain or not by said gain control device,
wherein said determining device determines whether the reception level of said radio wave is equal to or higher than the predetermined level or not on the basis of a result of detection by said gain detecting device.

4. The receiving apparatus according to claim 1, wherein said determining device determines whether or not BER (Bit Error Rate) obtained when said digital demodulating device demodulates said digital sound modulated wave signal is equal to or higher than a predetermined rate.

5. The receiving apparatus according to claim 1, wherein said analog demodulating device stops demodulation of said analog sound modulated wave signal on the basis of a result of determination by said determining device.

6. The receiving apparatus according to claim 1, further comprising a display device for displaying characters or an image,
wherein said receiving device receives a radio wave including at least an analog sound modulated wave signal, a digital sound modulated wave signal, and a digital character/image modulated wave signal,
said digital demodulating device demodulates the digital sound modulated wave signal and the digital character/image modulated wave signal received by said receiving device, and
said display device displays said character or image on the basis of a character/image demodulated signal obtained from said digital demodulating device irrespective of a result of determination made by said determining device.
